(19) United States
(12) Patent Application Publication
(10) Pub. No.: US 2012/0300968 A1
(43) Pub. Date: Nov. 29, 2012

(54) SOUND BOX STRUCTURE FOR ELECTRONIC APPARATUS

(76) Inventor: Tsai-Yun Sun, (US)

(21) Appl. No.: 13/472,959

(22) Filed: May 16, 2012

(30) Foreign Application Priority Data
May 23, 2011 (TW) 100117931

(51) Int. Cl. H04R 1/20; H04R 1/02

(52) U.S. Cl. 381/353

(57) ABSTRACT

The present disclosure relates to a sound box structure for an electronic apparatus. The sound box structure is disposed in an electronic apparatus and comprises a resonating cavity, a loudspeaker, and at least an electronic device. The loudspeaker and the electronic device are disposed in the resonating cavity. The present disclosure mainly combines the sound box structure disposed originally in the electronic apparatus with the accommodating space of other electronic devices for expanding the resonating space of the sound box structure for the electronic apparatus. Consequently, the output audio quality of the sound box structure for the electron apparatus can be improved, and hence enhancing the multimedia effects of the electronic apparatus.

### FIELD OF THE DISCLOSURE

The present disclosure relates generally to a sound box structure, and particularly to a sound box structure used in an electronic apparatus.

### BACKGROUND OF THE DISCLOSURE

Modern electronic technologies are developed so rapidly that various electronic apparatuses prevail in the society. Not only the computation capabilities are getting stronger but also the processing speed grows exponentially. Electronic apparatuses such as notebook computers, mobile phones, multimedia players, and personal digital assistants have become people's indispensable parts in learning, entertaining, and working; they are compact, convenient for carrying, and increasingly stronger functionality attract market and customers' attention and hence are adopted by the general public. In addition to enhanced operating performance, electronic apparatuses are further designed thinly with multimedia functions. Thereby, most of them will have a suitable tiny loudspeaker as the audio output interface.

With the prevalence of multimedia, music listening has gradually become modern people's daily entertainment. In addition to choosing excellent hi-fi equipment or other playback apparatuses, people are getting picky about the sound quality of the loudspeaker. For pursuing vivid sound quality and surround sound effect to make listener feel like real and enjoy higher-quality sound effects, it is necessary to install more speakers in the zoom. In order to save the space, modern mainstream speakers are designed in compact sizes. Thereby, the structure of loudspeakers are continuously developed and improved for exhibiting high-quality audio effects. For example, sound boxes made of various materials are installed to the loudspeakers for producing resonance.

In addition to vivid sound expression, the design of the sound boxes of loudspeakers also needs to meet the requirement of compactness, which is a major decision factor for consumers. Nonetheless, owing to the limitations imposed by technologies, materials, and relevant concepts, the sound boxes of electronic apparatuses are still limited by their design in shapes although they have already made leaps in the development of size and weight. If sound boxes are designed according to prior art, the requirements described above will never be met.

In the design of miniature and thin electronic apparatuses, their loudspeakers and sound boxes have to shrink accordingly. Under the circumstance of shrunk sound boxes, the output sound quality of electronic apparatuses will be far below expectation. Thereby, the present disclosure provides a sound box structure for an electronic apparatus, which mainly combines the sound box structure disposed originally in the electronic apparatus with the accommodating space of other electronic devices for expanding the resonating space of the sound box structure for the electronic apparatus. Consequently, the output audio quality of the sound box structure for the electron apparatus can be improved, and hence enhancing the multimedia effects of the electronic apparatus.

### SUMMARY

An objective of the present disclosure is to provide a sound box structure for an electronic apparatus, which mainly combines the sound box structure disposed originally in the electronic apparatus with the accommodating space of other electronic devices for expanding the resonating space of the sound box structure for the electronic apparatus. Consequently, the output audio quality of the sound box structure for the electron apparatus can be improved, and hence enhancing the multimedia effects of the electronic apparatus.

For achieving the objective described above, the present disclosure provides a sound box structure for an electronic apparatus. The sound box structure is disposed in an electronic apparatus and comprises a resonating cavity, a loudspeaker, and at least an electronic device. The loudspeaker and the electronic device are disposed in the resonating cavity for increasing the resonating space of the sound box structure, and thereby improving the output audio quality of the sound box structure as well as the multimedia effects of the electronic apparatus.

### BRIEF DESCRIPTION OF THE DRAWINGS

FIG. 1 shows a structural schematic diagram of the sound box structure according to a first embodiment of the present disclosure;

FIG. 2 shows a partial enlarged view of FIG. 1;

FIG. 3A shows a cross-sectional view of the first embodiment according to the present disclosure;

FIG. 3B shows a cross-sectional view of a second embodiment according to the present disclosure; and

FIG. 4 shows a structural schematic diagram of the sound box structure according to a third embodiment of the present disclosure.

### DETAILED DESCRIPTION

In order to make the structure and characteristics as well as the effectiveness of the present disclosure to be further understood and recognized, the detailed description of the present disclosure is provided as follows along with embodiments and accompanying figures.

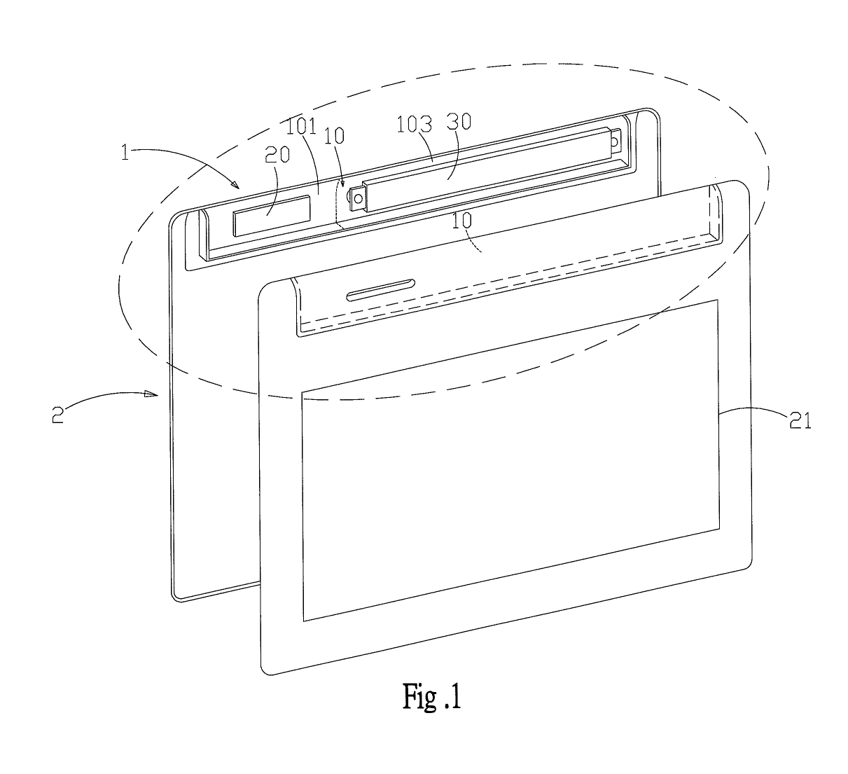

FIG. 1 shows a structural schematic diagram of the sound box structure according to a first embodiment of the present disclosure. As shown in the figure, the present disclosure provides a sound box structure for an electronic apparatus. The sound box structure 1 is disposed in an electronic apparatus 2. The electronic apparatus 2 according to the present embodiment can be portable electronic apparatuses such as notebook computers, tablet computers, personal digital assistants, and smart phones. The sound box structure 1 comprises a resonating cavity 10, a loudspeaker 20, and at least an electronic device 30. The loudspeaker 20 and the electronic device 30 are disposed in the resonating cavity 10. The electronic device 30 can be a wireless transmission module, an image extraction module, a touch module, or a sensing module. The electronic device 30 according to the present embodiment is a wireless transmission module, such as an antenna, a wireless network communication module, a GSM (Global System for Mobile Communications) module, or a Bluetooth transmission module.

The resonating cavity 10 according to the present embodiment is divided into a first accommodating space 101 and a second accommodating space 103. The loudspeaker 20 is located in the first accommodating space 101; the electronic device 30 is located in the second accommodating space 103. The first accommodating space 101 and the second accommodating space 103 communicate with each other. The above description is only an embodiment for arranging the loudspeaker 20 and the electronic device 30 according to the present disclosure. Other arrangements will not be described in details here. The present embodiment mainly combines the accommodating space of other electronic devices 30 for expanding the resonating cavity 10 of the sound box structure 1 and thus increasing the resonating space of the sound wave transmitted by the sound box structure 1. Consequently, the output audio quality of the sound box structure 1 can be improved, and hence enhancing the multimedia effects of the electronic apparatus 2.

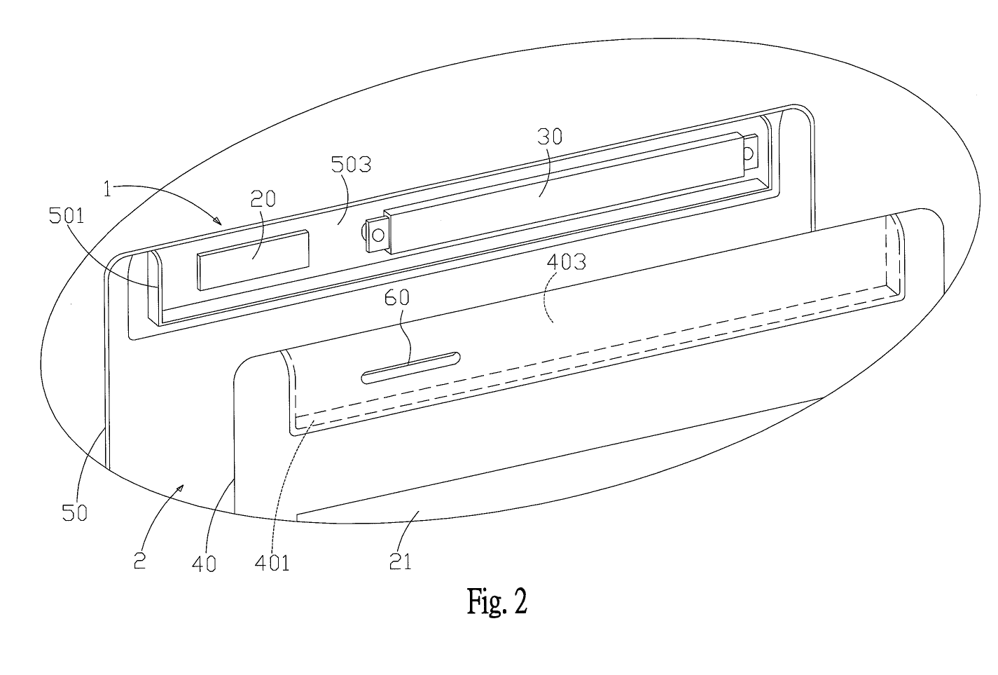

FIG. 2 shows a partial enlarged view of FIG. 1. As shown in the figure, the sound box structure 1 according to the present embodiment is located on the side of a display module 21 of the electronic apparatus 2. The sound box structure 1 further comprises a first housing 40 and a second housing 50, which are just the housings of the electronic apparatus 2. The first housing 40 has a first sidewall 401, which forms a first zone 403 in the first housing 40. The second housing 50 has a second sidewall 501, which forms a second zone 503 in the second housing 50. The first housing 40 is assembled with the second housing 50; the first sidewall 401 mates with and gets stuck to the second sidewall 501, combining the first zone 403 and the second zone 503 and forming the resonating cavity 501. At least an audio jack 60 can be disposed on the first housing 40 or the second housing 50. The loudspeaker 20 is disposed corresponding to the audio jack 60 for outputting sound.

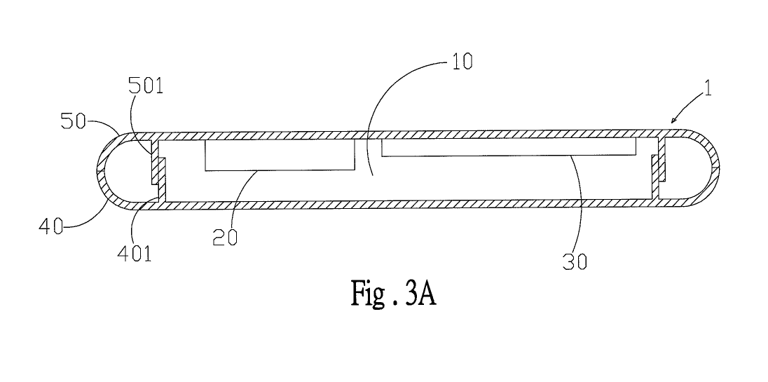

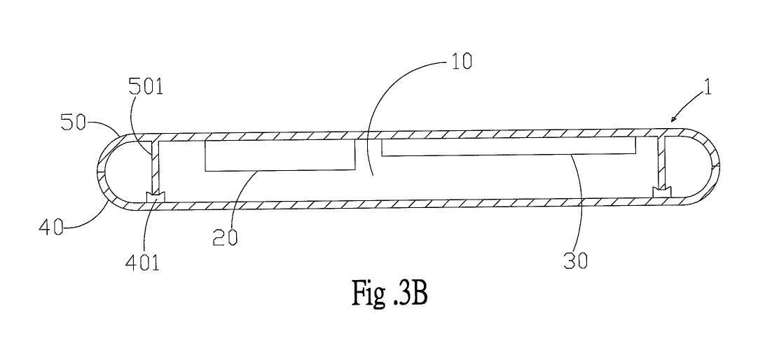

FIG. 3A shows a cross-sectional view of the first embodiment according to the present disclosure. As shown in the figure, the first and the second sidewalls 401, 501 are general convex ribs and can be formed integrally with the first and the second housings 40, 50. The length of the first sidewall 401 is shorter or longer than the second sidewall 501 so that the first sidewall 401 gets stuck to the inner or outer side of the second sidewall 501 for forming the resonating cavity 10.

FIG. 3B shows a cross-sectional view of a second embodiment according to the present disclosure. As shown in the figure, the first sidewall 401 (or the second sidewall 501) is a general convex rib; the second sidewall 501 (or the first sidewall 401) is a soft material. The second sidewall 501 corresponds to the first sidewall 401. The first housing 40 is assembled with the second housing 50. The first sidewall 401 pushes against the second sidewall 501. Because the second sidewall 501 is a soft material, it can mate tightly with the first sidewall 401 for forming the resonating cavity 10.

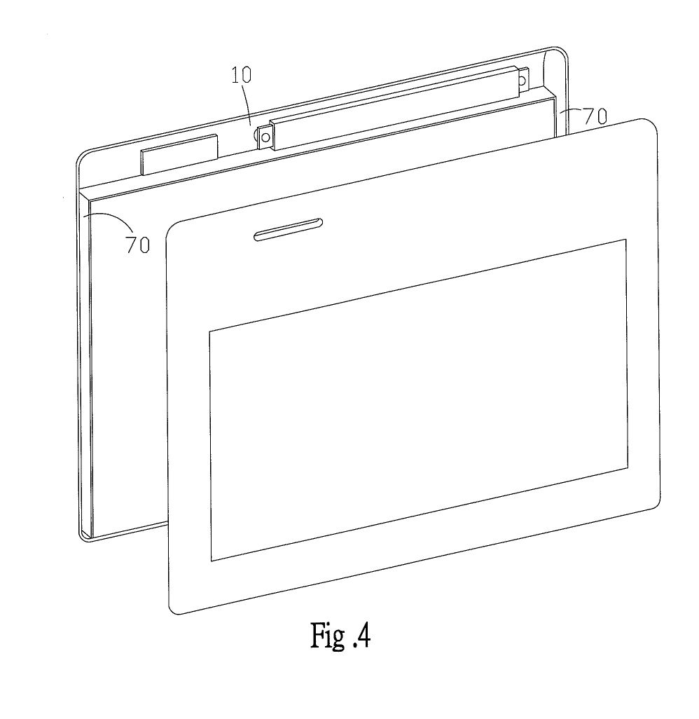

FIG. 4 shows a structural schematic diagram of the sound box structure according to a third embodiment of the present disclosure. As shown in the figure, the difference between the present embodiment and the previous one is that the present embodiment further comprises a reinforcing space 70, which extends on at least one side of the resonating cavity 10. Thereby, the output audio quality of the sound box structure 1 is enhanced, and thus improving the multimedia effects of the electronic apparatus 2.

To sum up, the present disclosure relates to a sound box structure for an electronic apparatus. The sound box structure is disposed in an electronic apparatus and comprises a resonating cavity, a loudspeaker, and at least an electronic device. The loudspeaker and the electronic device are disposed in the resonating cavity. The present disclosure mainly combines the sound box structure disposed originally in the electronic apparatus with the accommodating space of other electronic devices for expanding the resonating space of the sound box structure for the electronic apparatus. Consequently, the output audio quality of the sound box structure for the electron apparatus can be improved, and hence enhancing the multimedia effects of the electronic apparatus.

Accordingly, the present disclosure conforms to the legal requirements owing to its novelty, nonobviousness, and utility. However, the foregoing description is only embodiments of the present disclosure, not used to limit the scope and range of the present disclosure. Those equivalent changes or modifications made according to the shape, structure, feature, or spirit described in the claims of the present disclosure are included in the appended claims of the present disclosure.

1. A sound box structure for an electronic apparatus, disposed in an electronic apparatus, and comprising:
a resonating cavity;
a loudspeaker, disposed in said resonating cavity; and
at least an electronic device, disposed in said resonating cavity.

2. The sound box structure for an electronic apparatus of claim 1, and further comprising:
a first housing, having a first sidewall for forming a first zone in said first housing; and
a second housing, having a second sidewall for forming a second zone in said second housing, said second sidewall mating with and getting stuck to said first sidewall, and said first zone and said second zone combining to form said resonating cavity.

3. The sound box structure for an electronic apparatus of claim 1, wherein said sound box structure has at least an audio jack, and said loudspeaker corresponds to said audio jack.

4. The sound box structure for an electronic apparatus of claim 1, wherein said resonating cavity comprises:
a first accommodating space, accommodating said loudspeaker; and
a second accommodating space, accommodating said electronic device, and said first accommodating space and said second accommodating space communicating with each other.

5. The sound box structure for an electronic apparatus of claim 1, wherein said electronic apparatus has a display module, and said sound box structure is located on the side of said display module.

6. The sound box structure for an electronic apparatus of claim 1, wherein a reinforcing space is disposed extending on at least one side of said resonating cavity.

7. The sound box structure for an electronic apparatus of claim 1, wherein said electronic device can be an antenna, a wireless transmission module, an image extraction module, a touch module, or a sensing module.

8. The sound box structure for an electronic apparatus of claim 7, wherein said wireless transmission module is a Global System for Mobile Communications module.

9. The sound box structure for an electronic apparatus of claim 7, wherein said wireless transmission module is a Bluetooth transmission module.
